(19) United States
(12) Patent Application Publication
(10) Pub. No.: US 2025/0174212 A1
(43) Pub. Date: May 29, 2025

(54) SHEET MUSIC OUTPUT DEVICE, SHEET MUSIC OUTPUT METHOD, AND NON-TRANSITORY RECORDING MEDIUM

(71) Applicant: Roland Corporation, Shizuoka (JP)

(72) Inventor: Ryo Susami, Hamamatsu (JP)

(73) Assignee: Roland Corporation, Shizuoka (JP)

(21) Appl. No.: 18/954,402

(22) Filed: Nov. 20, 2024

(30) Foreign Application Priority Data
Nov. 24, 2023 (JP) 2023-199011

(51) Int. Cl. G10G 1/04

(52) U.S. Cl. CPC G10G 1/04

(57) ABSTRACT

In a sheet music output device, a sheet music output method, and a non-transitory recording medium, the non-transitory recording medium stores a sheet music output program that causes a computer to execute a sheet music output process outputting sheet music based on performance information. The sheet music output program causes the computer to: time a note-on time difference between adjacent notes in a series of notes included in the performance information; and output sheet music on which ornamental notes corresponding to the series of notes are arranged in a case where the note-on time difference of the series of notes timed in the timing satisfies a predetermined detection condition.

### CROSS-REFERENCE TO RELATED APPLICATION

This application claims the priority benefit of Japan application serial no. 2023-199011, filed on Nov. 24, 2023. The entirety of the above-mentioned patent application is hereby incorporated by reference herein and made a part of this specification.

### BACKGROUND

### Technical Field

The disclosure relates to a sheet music output device, a sheet music output method, and a non-transitory recording medium.

### Related Art

Patent Document 1 (Japanese Patent Application Laid-Open No. 2012-47983) describes creating sheet music information corresponding to MIDI data by analyzing the MIDI data. Specifically, information on pitch intervals and sound durations of a series of MIDI messages is acquired from target MIDI data, and sheet music information is created by sequentially arranging musical notes corresponding to the pitch intervals and the sound durations.

In the display of musical notes based on such MIDI messages, to display ornamental notes such as an appoggiatura, since time intervals between the series of MIDI messages are not associated with a predetermined time width (e.g., sixteenth note or thirty-second note) used in a quantization process, the time intervals may be shorter or longer than this time width. Upon performing a quantization process on such a series of MIDI messages, for example, a MIDI message at an earlier timing among the series of MIDI messages may be moved to a grid at a temporal position one step forward, and a MIDI message at a later timing among the series of MIDI messages may be moved to a grid one step backward. As a result, the series of MIDI messages is not accurately arranged as ornamental notes in the sheet music data.

### SUMMARY

A non-transitory recording medium of an embodiment of the disclosure stores a sheet music output program that causes a computer to execute a sheet music output process outputting sheet music based on performance information. The sheet music output program causes the computer to: time a note-on time difference between adjacent notes in a series of notes included in the performance information; and output sheet music on which ornamental notes corresponding to the series of notes are arranged in a case where the note-on time difference of the series of notes timed in the timing satisfies a predetermined detection condition.

A sheet music output device of an embodiment of the disclosure outputs sheet music based on performance information. The sheet music output device includes a processor configured to: time a note-on time difference between adjacent notes in a series of notes included in the performance information; and output sheet music on which ornamental notes corresponding to the series of notes are arranged in a case where the note-on time difference of the series of notes timed satisfies a predetermined detection condition.

A sheet music output method of an embodiment of the disclosure outputs sheet music based on performance information. The sheet music output method includes: timing a note-on time difference between adjacent notes in a series of notes included in the performance information; and outputting sheet music on which ornamental notes corresponding to the series of notes are arranged in a case where the note-on time difference of the series of notes timed in the timing satisfies a predetermined detection condition.

### BRIEF DESCRIPTION OF DRAWINGS

FIG. 1 is a view showing an external appearance of a PC.

FIG. 2A is a view for describing detection of ornamental notes of an appoggiatura. FIG. 2B is a view representing sheet music in the case where a detection method of ornamental notes of an appoggiatura in this embodiment is not used. FIG. 2C is a view representing sheet music in the case where the detection method of ornamental notes of an appoggiatura in this embodiment is used.

FIG. 3A is a view for describing detection of ornamental notes of an arpeggio. FIG. 3B is a view representing sheet music in the case where a detection method of ornamental notes of an arpeggio in this embodiment is not used. FIG. 3C is a view representing sheet music in the case where the detection method of ornamental notes of an arpeggio in this embodiment is used.

FIG. 4A is a view for describing detection of ornamental notes of a trill. FIG. 4B is a view representing sheet music in the case where a detection method of ornamental notes of a trill in this embodiment is not used. FIG. 4C is a view representing sheet music in the case where the detection method of ornamental notes of trill in this embodiment is used.

FIG. 5A is a block diagram showing an electrical configuration of the PC. FIG. 5B is a view schematically showing music data. FIG. 5C is a view for describing instruction markers.

FIG. 6A is a view schematically showing a parameter table. FIG. 6B is a view schematically showing sheet music data.

FIG. 7 is a functional block diagram of the PC.

FIG. 8 is a flowchart of a main process.

FIG. 9 is a flowchart of an ornamental note detection process.

FIG. 10 is a flowchart of a detection condition setting process.

FIG. 11 is a flowchart of an appoggiatura detection process.

FIG. 12 is a flowchart of a candidate note acquisition process.

FIG. 13A is a flowchart of an arpeggio detection process. FIG. 13B is a flowchart of a trill detection process.

FIG. 14 is a view schematically showing a parameter table in a modification example.

### DESCRIPTION OF EMBODIMENTS

Embodiments of the disclosure provide a sheet music output device, a sheet music output method, and a non-transitory recording medium capable of accurately arranging ornamental notes on sheet music to be outputted.

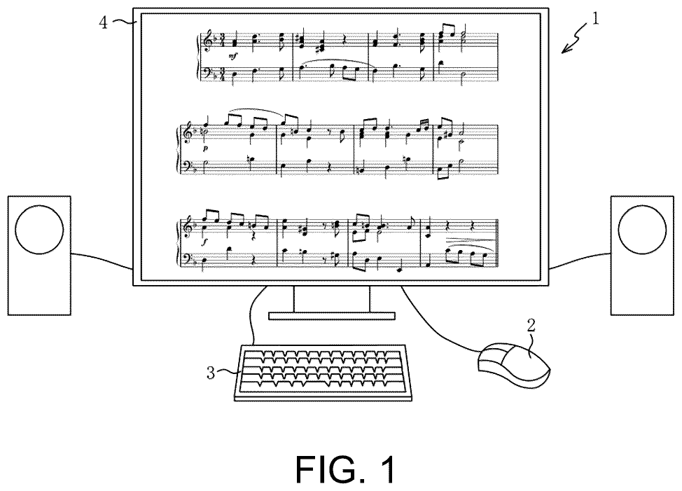

Hereinafter, an exemplary embodiment will be described with reference to the accompanying drawings. First, referring to FIG. 1, an overview of a PC 1 of this embodiment will be described. FIG. 1 is an external view of the PC 1. The PC 1 is an information processing device (a computer, a sheet music output device) that creates sheet music based on performance information set in music data M (to be described later), and outputs the created sheet music. The PC 1 is provided with a mouse 2 and a keyboard 3 for inputting an instruction from a user H, and a display device 4 for displaying sheet music and the like created based on the music data M.

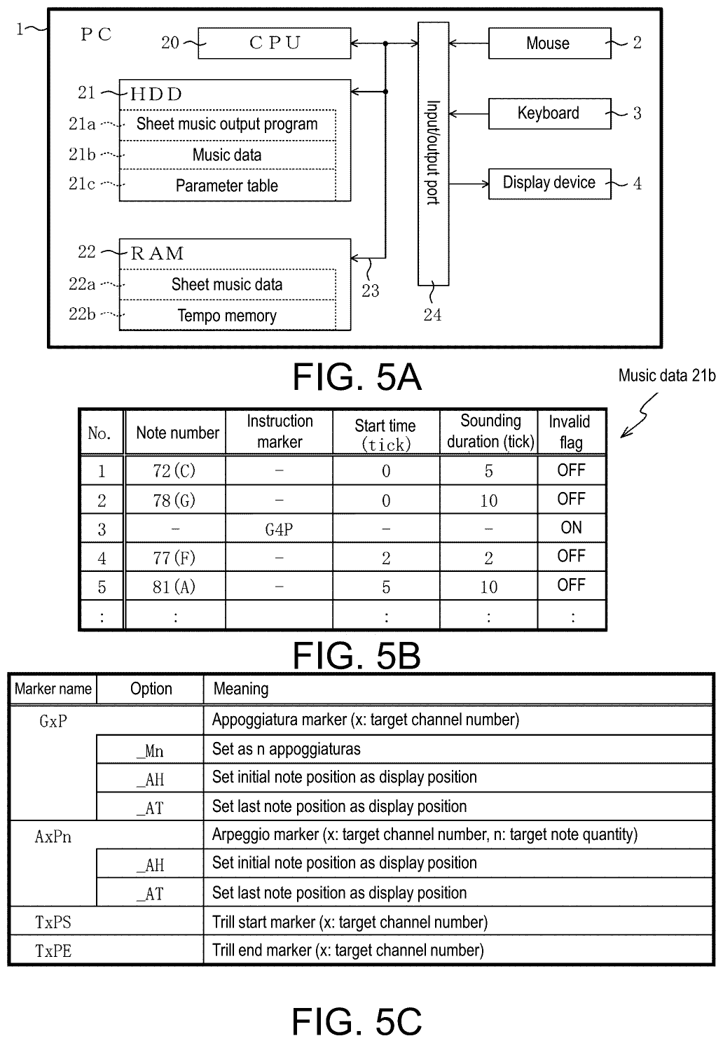

The music data M is data composed of performance information of music in a MIDI (Musical Instrument Digital Interface) format and instruction markers (instruction information) which are information for setting ornamental notes using the performance information. Specifically, in the music data M, first, notes constituting the performance information are arranged in a sequence of output. The notes arranged in the music data M are set based on an input of the user H to an electronic musical instrument such as a MIDI keyboard. Furthermore, in the music data M, instruction markers are appropriately arranged between notes. Details of the instruction markers will be described later in FIG. 5.

In the PC 1, notes arranged as performance information in the music data M are acquired in a sequence in which the notes are arranged, and musical notes corresponding to the acquired notes are acquired. Then, sheet music on which the acquired musical notes are arranged is displayed on the display device 4. At this time, a note-on time difference ΔL of a series of notes acquired from the music data M is timed, and according to the note-on time difference ΔL, ornamental notes corresponding to the series of notes are acquired and displayed on the sheet music.

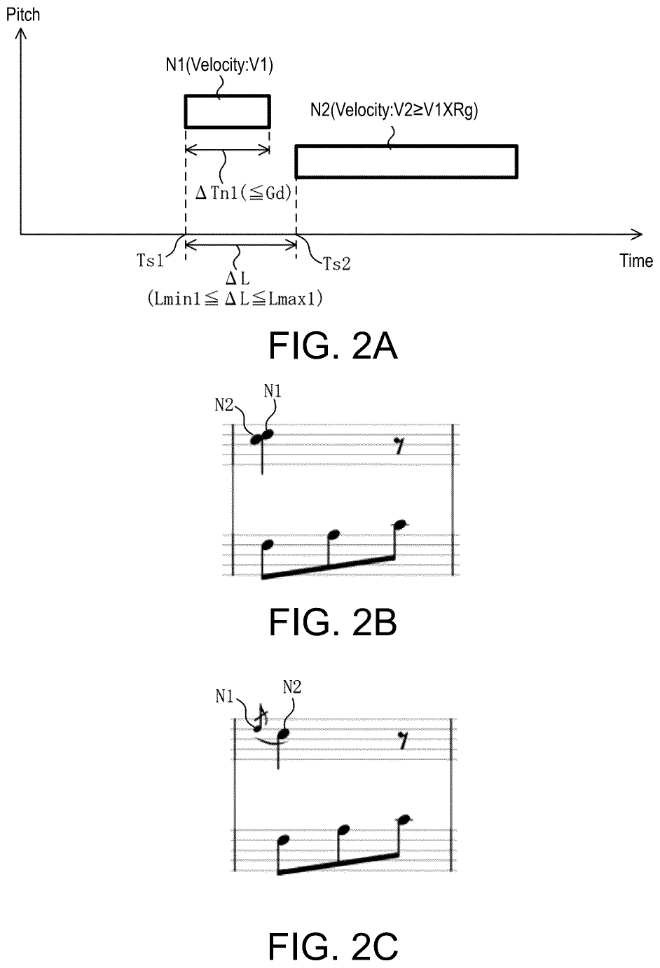

Herein, the note-on time difference ΔL refers to a time difference between times (hereinafter referred to as “start times”) at which adjacent notes in the series of notes are respectively turned on. In this embodiment, ornamental notes of an appoggiatura, an arpeggio, and a trill are acquired according to the timed note-on time difference ΔL. Referring to FIG. 2A to FIG. 4C, detection methods of the respective ornamental notes will be described. First, referring to FIG. 2, detection of ornamental notes of an appoggiatura will be described.

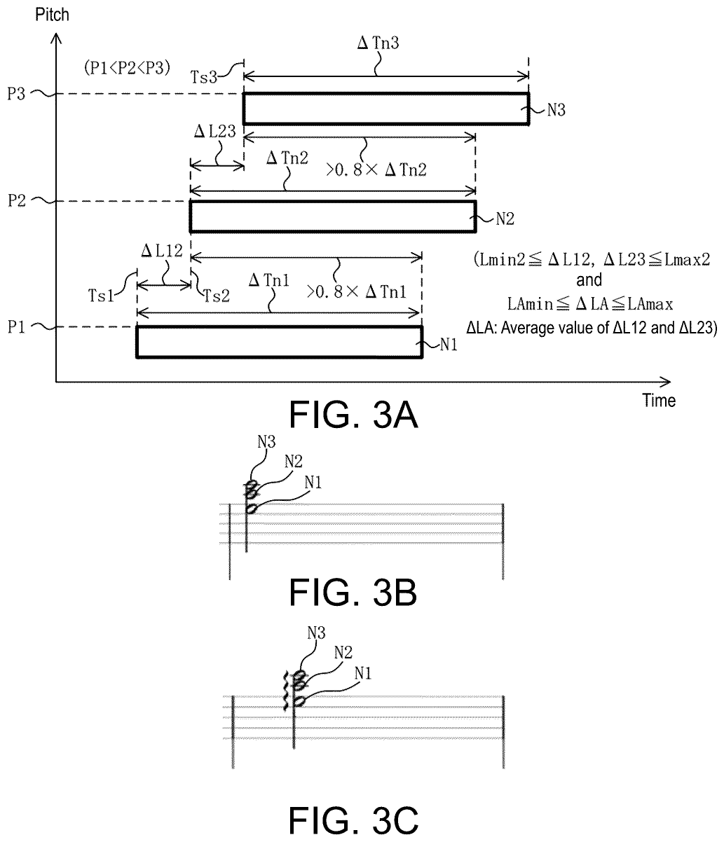

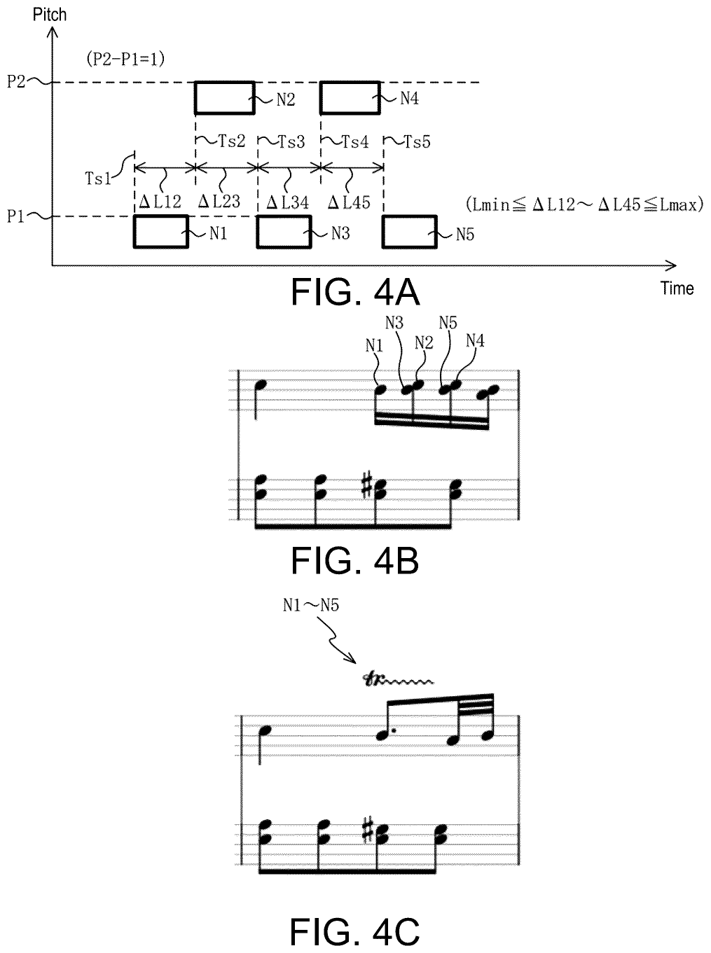

FIG. 2A is a view for describing detection of ornamental notes of an appoggiatura. FIG. 2A represents a case where a series of notes acquired from the music data M is notes N1 and N2, with the horizontal axis of FIG. 2A representing time and the vertical axis representing pitch. The same also applies to FIG. 3A and FIG. 4A to be described later.

In a series of notes acquired from the music data M, note-on time differences ΔL between adjacent notes among the series of notes are respectively measured. Herein, the note-on time difference ΔL is timed as a time difference taking actual time (e.g., seconds) as a unit time. Respective velocities of the series of notes are acquired, and sounding durations of all notes other than a last note among the series of notes (hereinafter referred to as a “last note”) are timed, i.e., respective durations from note-on to note-off of all notes other than the last note are timed.

Then, in the following case, it is detected that the series of notes is ornamental notes of an appoggiatura: each of the timed note-on time differences ΔL is equal to or greater than a first time difference Lmin1 and equal to or less than a second time difference Lmax1; a quantity of notes of the series of notes is equal to or greater than a first predetermined number Nmin1 and equal to or less than a second predetermined number Nmax1; ratios of the velocity of the last note of the series of notes to velocities of notes other than the last note among the series of notes are all equal to or greater than a velocity ratio Rg; and sounding durations of notes other than the last note of the series of notes are equal to or less than a maximum sounding duration Gd.

In this embodiment, whether the ratios of the velocity of the last note to the velocities of the notes other than the last note are all equal to or greater than the velocity ratio Rg is determined by, first, calculating multiplication values obtained by multiplying the velocities of the notes other than the last note respectively by the velocity ratio Rg, and determining whether the velocity of the last note is equal to or greater than all the calculated multiplication values. Whether the ratio of the velocity of the last note to the velocity of any note other than the last note is all equal to or greater than the velocity ratio Rg may also be determined according to other methods, such as determining by comparing division values obtained by dividing the velocity of the last note by the velocities of the notes other than the last note with the velocity ratio Rg.

Such detection of ornamental notes of an appoggiatura is performed before execution of a quantization process that aligns the notes of the music data M to temporal “grids” set at predetermined time intervals (e.g., sixteenth notes or thirty-second notes). Similarly, detection of an arpeggios or a trill to be described later in FIG. 3A and FIG. 4A is also performed before execution of the quantization process.

Among the detection conditions for detecting ornamental notes of an appoggiatura, the first time difference Lmin1 is a time difference lower limit value, the second time difference Lmax1 is a time difference upper limit value, and the first predetermined number Nmin1 and the second predetermined number Nmax1 are note quantity ranges. In this embodiment, the first predetermined number Nmin1 and the second predetermined number Nmax1 are respectively set to a lower limit value and an upper limit value of a number obtained by adding a quantity (i.e., “1”) of notes (e.g., the note N2 in FIG. 2C to be described later) to which the appoggiatura is appended, to a quantity of notes (e.g., the note N1 in FIG. 2C to be described later) to be taken as the appoggiatura among the series of notes. Although the first predetermined number Nmin1 and the second predetermined number Nmax1 have been set to a total number of the notes to be taken as the appoggiatura and the notes to which the appoggiatura is appended, the disclosure is not limited thereto. For example, it is also possible to set to the quantity of notes to be taken as the appoggiatura alone.

Herein, as examples, the first time difference Lmin1 is “20 milliseconds”, the second time difference Lmax1 is “40 milliseconds”, the first predetermined number Nmin1 is “2 notes” (i.e., the quantity of notes to be taken as the appoggiatura is “1”), the second predetermined number Nmax1 is “5 notes” (i.e., the quantity of notes to be taken as the appoggiatura is “4”), the velocity ratio Rg is “0.9”, and the maximum sounding duration Gd is “130 milliseconds”. The first time difference Lmin1, the second time difference Lmax1, the first predetermined number Nmin1, the second predetermined number Nmax1, the velocity ratio Rg, and the maximum sounding duration Gd may also be set to values other than those described above.

In FIG. 2A, the quantity of notes of the series of notes is 2, including the notes N1 and N2. The note N1 has a start time of Ts1, a velocity of V1, and a sounding duration of ΔTn1. The note N2 has a start time of Ts2, which is at a timing later than Ts1, and a velocity of V2. Since the series of notes acquired from the music data M only includes the notes N1 and N2, the note N2 is taken as the last note described above. The note-on time difference ΔL between the note N1 and the note N2 is set as a difference between the start time Ts2 and the start time Ts1. For example, in the case where the note-on time difference ΔL is 30 milliseconds, the sounding duration ΔTn1 is 100 milliseconds, the velocity V1 is 10, and the velocity V2 is 30, it is detected that the note N1 is a note to be taken as an appoggiatura, and the note N2 is a note to which the appoggiatura is appended.

Next, referring to FIG. 2B and FIG. 2C, a case where the detection method of ornamental notes of an appoggiatura of this embodiment is used and a case where such a detection method is not used will be compared with each other. FIG. 2B is a view representing sheet music in the case where the detection method of ornamental notes of an appoggiatura of this embodiment is not used, and FIG. 2C is a view representing sheet music in the case where the detection method of ornamental notes of an appoggiatura of this embodiment is used.

In FIG. 2B, in the case where the detection method of ornamental notes of an appoggiatura of this embodiment is not used, the notes N1 and N2, which originally should be displayed as ornamental notes of an appoggiatura, are displayed as a chord. In FIG. 2B, although the musical note corresponding to the note N2 is represented to the left of the musical note corresponding to the note N1, this represents that the notes N1 and N2 are sounded simultaneously. This also applies to FIG. 4B to be described later. The reason why the notes N1 and N2 are displayed as a chord in this manner lies in that, as a result of performing a quantization process on the music data M, the start times of the notes N1 and N2 are set to the same grid.

In contrast, in the detection method of ornamental notes of an appoggiatura of this embodiment, in the case where the note-on time difference ΔL between the notes N1 and N2 before a quantization process is performed on the music data M is respectively equal to or greater than the first time difference Lmin1 and equal to or less than the second time difference Lmax1, it is detected that the note N1 is a note to be taken as an appoggiatura, and the note N2 is a note to which the appoggiatura is appended. Accordingly, as shown in FIG. 2C, from the notes N1 and N2 which should be taken as ornamental notes of an appoggiatura and in which the note-on time difference ΔL is equal to or greater than the first time difference Lmin1 and equal to or less than the second time difference Lmax1, ornamental notes of an appoggiatura can be accurately set.

Further, a time based on actual time is used as the note-on time difference ΔL. Herein, performances taken as ornamental notes of an appoggiatura and the like are often played with a rhythm that does not depend on a tempo set in the music. For example, upon acquiring the note-on time difference ΔL with a sixteenth note corresponding to the tempo taken as a unit time, since a length of the unit time changes according to a magnitude of the tempo, accuracy of the note-on time difference ΔL decreases. Accordingly, in the music data M, there is a risk that notes that should be taken as ornamental notes of an appoggiatura may be determined as a chord, and ornamental notes of an appoggiatura cannot be accurately set.

In contrast, in the detection method of ornamental notes of an appoggiatura of this embodiment, a time based on actual time is used as the note-on time difference ΔL. Accordingly, since the note-on time difference ΔL can be configured as a time independent of the tempo set in the music of the music data M, ornamental notes of an appoggiatura can be set more accurately from the series of notes.

Further, in addition to the note-on time difference ΔL, the detection conditions of ornamental notes of an appoggiatura also include conditions that the velocity of the last note is equal to or greater than the velocities of the other notes, and the sounding durations of the notes other than the last note are short. Accordingly, it is possible to accurately detect a state in which an appoggiatura may occur, i.e., a state in which the sounding durations of the notes other than the last note are short, and furthermore, the velocity of the last note is sufficiently larger than the other notes, so it becomes possible to set ornamental notes of an appoggiatura with higher accuracy.

The detection conditions of an appoggiatura are not limited to conditions of the first time difference Lmin1, the second time difference Lmax1, the first predetermined number Nmin, the second predetermined number Nmax, the velocity ratio Rg, and the maximum sounding duration Gd. Some of these conditions may be omitted, or other conditions, such as conditions related to pitches of the series of notes, may also be added in addition to the above conditions.

Next, referring to FIG. 3A to FIG. 3C, detection of ornamental notes of an arpeggio will be described. FIG. 3A is a view for describing detection of ornamental notes of an arpeggio. FIG. 3A represents a case where a series of notes acquired from the music data M is notes N1 to N3.

In the detection of ornamental notes of an arpeggio, in the following case, it is detected that the series of notes is ornamental notes of an arpeggio: respective note-on time differences ΔL of the series of notes acquired from the music data M are equal to or greater than a third time difference Lmin2 and equal to or less than a fourth time difference Lmax2; an average value of the note-on time differences ΔL is equal to or greater than a first average value LAmin and equal to or less than a second average value LAmax; a quantity of notes of the series of notes is equal to or greater than a third predetermined number Nmin2 and equal to or less than a fourth predetermined number Nmax2; in the series of notes, respective sounding periods of adjacent notes overlap by a predetermined ratio or more or a pedal is pressed; and the series of notes are arranged in an ascending pitch sequence.

Among these detection conditions for detecting ornamental notes of an arpeggio, the third time difference Lmin2 and the first average value LAmin are time difference lower limit values, the fourth time difference Lmax2 and the second average value LAmax are time difference upper limit values, and the third predetermined number Nmin2 and the fourth predetermined number Nmax2 are note quantity ranges.

Herein, as examples, the third time difference Lmin2 is “30 milliseconds”, the fourth time difference Lmax2 is “150 milliseconds”, the first average value LAmin is “60 milliseconds”, the second average value LAmax is “120 milliseconds”, the third predetermined number Nmin2 is “3 notes”, the fourth predetermined number Nmax2 is “5 notes”, and the predetermined ratio is “80%”. The third time difference Lmin2, the fourth time difference Lmax2, the first average value LAmin, the second average value LAmax, the third predetermined number Nmin2, the fourth predetermined number Nmax2, and the predetermined ratio may also be set to values other than those described above.

In FIG. 3A, the quantity of notes of the series of notes is 3, including notes N1 to N3, and start times of the notes N1 to N3 are Ts1 to Ts3, respectively. From the start times Ts1 to Ts3, a note-on time difference ΔL12 between the note N1 and the note N2, and a note-on time difference ΔL23 between the note N2 and the note N3 are timed. The note-on time differences ΔL12 and ΔL23 are also timed as time differences taking actual time as a unit time.

Furthermore, an average value ΔLA of the note-on time difference ΔL12 and the note-on time difference ΔL23 is calculated. Further, sounding durations ΔTn1 to ΔTn3 of the notes N1 to N3 are timed. From the sounding durations ΔTn1 to ΔTn3, a length of an overlapping period between the sounding period of the note N1 and the sounding period of the note N2, and a length of an overlapping period between the sounding period of the note N2 and the sounding period of the note N3 are acquired. In FIG. 3A, the sounding period of the note N1 and the sounding period of the note N2 overlap by a period greater than 80%, and the sounding period of the note N2 and the sounding period of the note N3 also overlap by a period greater than 80%.

For example, in the case where the note-on time difference ΔL12 is 80 milliseconds, the note-on time difference ΔL23 is 100 milliseconds (accordingly, the average value ΔLA is 90 milliseconds), and pitches P1 to P3 of the notes N1 to N3 are P1<P2<P3, it is detected that the notes N1 to N3 are ornamental notes of an arpeggio.

Referring to FIG. 3B and FIG. 3C, a case where the determination method of ornamental notes of an arpeggio in this embodiment is used and a case where such a determination method is not used will be compared with each other. FIG. 3B is a view representing sheet music in the case where the detection method of ornamental notes of an arpeggio in this embodiment is not used, and FIG. 3C is a view representing sheet music in the case where the detection method of ornamental notes of an arpeggio in this embodiment is used.

In FIG. 3B, in the case where the detection method of ornamental notes of an arpeggio in this embodiment is not used, the notes N1 to N3, which originally should be displayed as ornamental notes of an arpeggio, are displayed as a chord. This is because, as a result of performing a quantization process on the music data M, the start times of the notes N1 to N3 are set to the same grid.

In contrast, in the detection method of ornamental notes of an arpeggio in this embodiment, similarly, the notes N1 to N3 are set as ornamental notes of an arpeggio in the case where the respective note-on time differences ΔL12 and ΔL23 of the notes N1 to N3 before the quantization process is performed on the music data M are equal to or greater than the third time difference Lmin2 and equal to or less than the fourth time difference Lmax2. Accordingly, as shown in FIG. 3C, from the notes N1 to N3, which should be taken as ornamental notes of an arpeggio, ornamental notes of an arpeggio can be set accurately.

Further, by using times based on actual time as the note-on time differences ΔL12 and ΔL23, since the note-on time differences ΔL12 and ΔL23 can be configured as times independent of the tempo set in the music of the music data M, ornamental notes of an arpeggio can be more accurately acquired from the series of notes.

In addition to the note-on time differences ΔL12 and ΔL23, the detection conditions of ornamental notes of an arpeggio also include: the average value ΔLA of the note-on time differences is equal to or greater than the first average value LAmin and equal to or less than the second average value LAmax; the respective sounding periods of adjacent notes in the series of notes overlap by a predetermined ratio or more; and the series of notes are arranged in an ascending pitch sequence. Accordingly, it is possible to accurately detect a state in which an arpeggio may occur, i.e., a state in which each note-on time difference ΔL has a small variation in the series of notes, the respective sounding periods of the series of notes overlap, and furthermore, sounding starts from a lowest pitch sound in the series of notes, so it becomes possible to set ornamental notes of an arpeggio with higher accuracy.

The detection conditions of an arpeggio are not limited to conditions of the third time difference Lmin2, the fourth time difference Lmax2, the first average value LAmin, the second average value LAmax, the third predetermined number Nmin2, the fourth predetermined number Nmax2, the predetermined ratio or the state of the pedal, and the pitch. Some of these conditions may be omitted, or other conditions, such as conditions related to velocities of the series of notes, may also be added in addition to the above conditions.

Next, referring to FIG. 4A to FIG. 4C, detection of ornamental notes of a trill will be described. FIG. 4A is a view for describing setting of ornamental notes of a trill. FIG. 4A represents a case where a series of notes acquired from the music data M is notes N1 to N5.

In the detection of ornamental notes of a trill, in the following case, it is detected that the series of notes is ornamental notes of a trill: respective note-on time differences ΔL of the series of notes acquired from the music data M are equal to or greater than a fifth time difference Lmin3 and equal to or less than a sixth time difference Lmax3; a quantity of notes of the series of notes is equal to or greater than a fifth predetermined number Nt; and the series of notes alternately repeats sounds that differ by a whole tone or a semitone. Among these detection conditions for detecting ornamental notes of a trill, the fifth time difference Lmin3 is a time difference lower limit value, the sixth time difference Lmax3 is a time difference upper limit value, and the fifth predetermined number Nt is a note quantity range.

Herein, as examples, the fifth time difference Lmin3 is “30 milliseconds”, the sixth time difference Lmax3 is “100 milliseconds”, and the fifth predetermined number Nt is “5 notes”. The fifth time difference Lmin3, the sixth time difference Lmax3, and the fifth predetermined number Nt may also be set to values other than those described above.

In FIG. 4A, the quantity of notes of the series of notes is 5, including the notes N1 to N5, and start times of the notes N1 to N5 are Ts1 to Ts5, respectively. From the start times Ts1 to Ts5, a note-on time difference ΔL12 between the note N1 and the note N2, a note-on time difference ΔL23 between the note N2 and the note N3, a note-on time difference ΔL34 between the note N3 and the note N4, and a note-on time difference ΔL45 between the note N4 and the note N5 are acquired.

For example, in the following case, it is detected that the notes N1 to N5 are ornamental notes of a trill: the note-on time difference ΔL12 is 50 milliseconds; the note-on time difference ΔL23 is 80 milliseconds; the note-on time difference ΔL34 is 60 milliseconds; the note-on time difference ΔL45 is 45 milliseconds; pitches of the notes N1, N3, and N5 are P1; pitches of the notes N2 and N4 are P2; the pitch P2 and the pitch P1 differ by a whole tone or a semitone; and furthermore, sounding of the notes N1, N3, and N5 of the pitch P1 and sounding of the notes N2 and N4 of the pitch P2 start alternately.

Referring to FIG. 4B and FIG. 4C, a case where the determination method of ornamental notes of a trill in this embodiment is used and a case where such a determination method is not used will be compared with each other. FIG. 4B is a view representing sheet music in the case where the detection method of ornamental notes of a trill in this embodiment is not used, and FIG. 4C is a view representing sheet music in the case where the detection method of ornamental notes of a trill in this embodiment is used.

In FIG. 4B, in the case where the detection method of ornamental notes of a trill in this embodiment is not used, among the notes N1 to N5 which originally should be displayed as ornamental notes of a trill, the note N1 is displayed as a single musical note, the notes N2 and N3 are displayed as a chord, and the notes N4 and N5 are also displayed as a chord. The reason why the note N1 is displayed as a single musical note, the notes N2 and N3 are displayed as a chord, and the notes N4 and N5 are also displayed as a chord in this manner lies in that, as a result of performing a quantization process on the music data M, the note N1 alone is set to a grid, the notes N2 and N3 are set to a next grid, and the notes N4 and N5 are set to a further next grid.

In contrast, in the detection method of ornamental notes of a trill in this embodiment, similarly, the notes N1 to N5 are taken as ornamental notes of a trill in the case where the respective note-on time differences ΔL12 to ΔL45 of the notes N1 to N5 before the quantization process is performed on the music data M are equal to or greater than the fifth time difference Lmin3 and equal to or less than the sixth time difference Lmax3. Accordingly, as shown in FIG. 4C, from the notes N1 to N5 which should be taken as ornamental notes of a trill, ornamental notes of a trill can be set accurately.

Further, by using times based on actual time as the note-on time differences ΔL12 to ΔL45, since the note-on time differences ΔL12 to ΔL45 can be configured as times independent of the tempo set in the music of the music data M, ornamental notes of a trill can be more accurately acquired from the series of notes.

In addition to the note-on time differences ΔL12 to ΔL45, the detection conditions of ornamental notes of a trill also include the quantity of notes of the series of notes and a condition that the notes N1 to N5 are notes that alternately repeat sounds differing by a whole tone or a semitone. Accordingly, it is possible to accurately detect a state in which a trill may occur, i.e., a state of being composed of multiple notes alternately repeating sounds differing by a whole tone or a semitone, so it becomes possible to set ornamental notes of a trill with higher accuracy.

The detection conditions of a trill are not limited to conditions of the fifth time difference Lmin3, the sixth time difference Lmax3, the fifth predetermined number Nt, and the pitch. Some of these conditions may be omitted, or other conditions, such as conditions related to velocities of the series of notes, may also be added in addition to the above conditions.

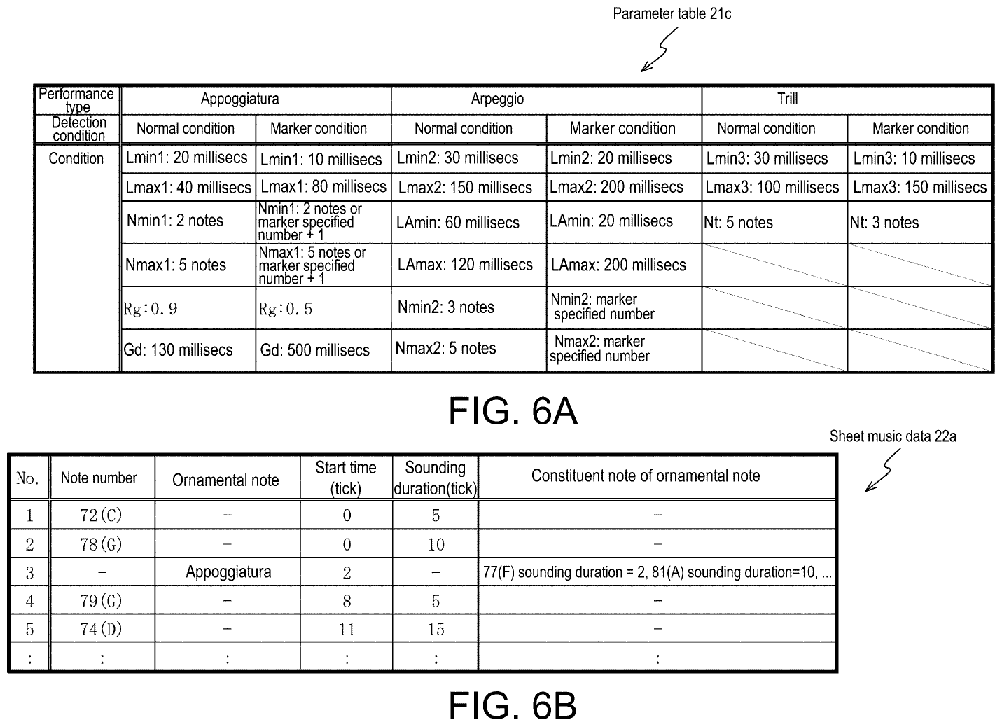

Next, referring to FIG. 5A to FIG. 6B, an electrical configuration of the PC 1 will be described. FIG. 5A is a block diagram showing the electrical configuration of the PC 1. The PC 1 includes a CPU 20, a hard disk drive (HDD) 21, and a RAM 22, which are respectively connected to an input/output port 24 via a bus line 23. The input/output port 24 is further connected to the mouse 2, the keyboard 3, and the display device 4 described above.

The CPU 20 is an arithmetic device that controls each part connected via the bus line 23. The HDD 21 is a rewritable non-volatile storage device that stores programs executed by the CPU 20, fixed value data, etc., and stores a sheet music output program 21a, music data 21b, and a parameter table 21c. Upon execution of the sheet music output program 21a in the CPU 20, a main process in FIG. 8 is executed. The music data 21b stores the music data M described above. Herein, referring to FIG. 5B, FIG. 5C, and FIG. 6A, the music data 21b and the parameter table 21c will be described.

FIG. 5B is a view schematically showing the music data 21b. The music data 21b is composed of the music data M, i.e., performance information related to notes based on the MIDI method for outputting as music, and instruction markers. Specifically, in the music data M, notes constituting the performance information are arranged in a sequence of output, and instruction markers are further appropriately arranged between the arranged notes.

The instruction marker is information (instruction information) for relaxing a detection condition used in detecting ornamental notes with respect to the notes arranged immediately after the instruction marker. When creating sheet music, notes or instruction markers are acquired sequentially from an initial position (i.e., “No. 1”) of the music data M. In the case where an instruction marker is acquired, the detection condition for detecting an appoggiatura, an arpeggio, or a trill with respect to the notes acquired immediately after the instruction marker is changed from a normal condition to a marker condition in which a condition is relaxed. The instruction markers are set by the user H who creates the music data M, and are also set after detection of an appoggiatura, an arpeggio, or a trill.

Herein, referring to FIG. 5C, types of the instruction markers will be described. FIG. 5C is a view for describing the instruction markers. In this embodiment, an appoggiatura marker, an arpeggio marker, a trill start marker, and a trill end marker are provided as the instruction markers.

The appoggiatura marker is an instruction marker that changes the detection condition of ornamental notes of an appoggiatura from a normal condition to a marker condition. The appoggiatura marker is expressed as “GxP”, where “x” is a parameter specified by a target channel number to which the note to be detected as an appoggiatura belongs among channels of the MIDI. For example, in the case of detecting ornamental notes of an appoggiatura from notes with the channel number being “1”, “G1P” is set as the appoggiatura marker.

The appoggiatura marker is provided with three options including “_Mn”, “_AH”, and “_ΔT”. The “_Mn” option is an option for specifying a quantity of notes to be taken as appoggiaturas among the series of notes. In the case of actually appending the “_Mn” option to the appoggiatura marker, the quantity of notes to be taken as an appoggiatura is specified (e.g., “_M5”) in place of the English letter “n”. In the case where the “_Mn” option is appended to the appoggiatura marker, each of the first predetermined number Nmin1 and the second predetermined number Nmax1 of the detection condition of an appoggiatura is set to “n+1”, which is obtained by adding the quantity of notes (i.e., “1”) to which an appoggiatura is appended among the series of notes, to the quantity specified by “n” of the “_Mn” option.

On the other hand, in the case where the quantity of notes to be taken as an appoggiatura is not specified, the “_Mn” option is omitted from the appoggiatura marker, and in that case, the first predetermined number Nmin1 and the second predetermined number Nmax1 are respectively set to “2 notes” and “5 notes” described above. Although “n” in the “_Mn” option specifies the quantity of notes to be taken as an appoggiatura, the disclosure is not limited thereto, and “n” may also specify the total number of notes to be taken as an appoggiatura and notes to which the appoggiatura is appended.

The “_AH” option is an option (position adjustment information) that sets positions at which ornamental notes of the appoggiatura are arranged on the sheet music to positions based on the start time of the initial note among the series of notes constituting the appoggiatura. Further, the “_AT” option is an option (position adjustment information) that sets positions at which ornamental notes of the appoggiatura are arranged on the sheet music to positions based on the start time of the last note among the series of notes constituting the appoggiatura. The “_AH” option and the “_AT” option are configured such that only one of them can be specified.

Since the notes set in the music data M are based on performance information inputted from a MIDI keyboard or the like by the user H, the start times of the notes do not necessarily coincide with the “grids” after the quantization process. Thus, by setting the “_AH” or “_AT” option, the positions at which ornamental notes of an appoggiatura are arranged on the sheet music can be arranged at positions intended by the user H at the initial note or the last note among the series of notes.

For example, an appoggiatura marker “G1P_M3” indicates that the channel number for detecting ornamental notes of an appoggiatura is “1”, and 3 appoggiaturas (i.e., multiple appoggiaturas composed of 3 musical notes) are detected. Further, an appoggiatura marker “G2P_AH” indicates that the channel number for detecting ornamental notes of an appoggiatura is “2”, and positions of ornamental notes of the detected appoggiatura on the sheet music are set to positions based on the start time of the initial note among the series of notes.

The arpeggio marker is an instruction marker that changes the detection condition of ornamental notes of an arpeggio from a normal condition to a marker condition. The arpeggio marker is expressed as “AxPn”, wherein “x” is a parameter that specifies a target channel number to which notes to be detected as an arpeggio belong among channels of the MIDI. Further, “n” is a parameter that specifies a quantity of notes to be taken as an arpeggio among the series of notes. For example, in the case where the channel number for detecting ornamental notes of an arpeggio is “3” and the quantity of notes to be taken as an arpeggio is “5”, “A3P5” is set as the arpeggio marker.

The arpeggio marker is provided with two options including “_AH” and “_AT”, similar to the appoggiatura marker. For example, an arpeggio marker “A2P4_AH” indicates that an arpeggio composed of 4 notes with the channel number being “2” is detected, and positions of ornamental notes of the detected arpeggio on the sheet music are set to positions based on the start time of the initial note among the series of notes. Further, an arpeggio marker “A4P5_AT” indicates that an arpeggio composed of 5 notes with the channel number being “4” for detecting ornamental notes of an arpeggio is detected, and positions of ornamental notes of the detected arpeggio on the sheet music are set to positions based on the start time of the last note among the series of notes.

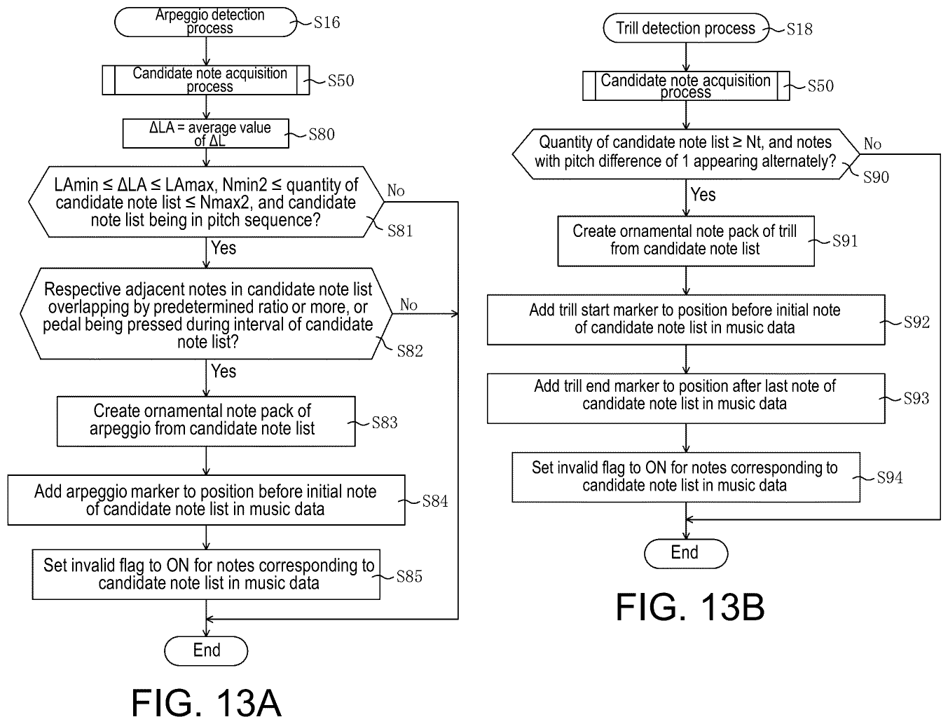

The trill start marker is an instruction marker that changes the detection condition of ornamental notes of a trill from a normal condition to a marker condition. The trill end marker is an instruction marker that changes the detection condition of ornamental notes of a trill from the marker condition to the normal condition, and instructs execution of a trill detection process (to be described later in FIG. 13B) using the notes acquired after acquisition of the trill start marker. The trill start marker is expressed as “TxPS”, and the trill end marker is expressed as “TxPE”. In the trill start marker and the trill end marker, “x” is a parameter that specifies a target channel number to which the notes to be detected as a trill belong among channels of the MIDI.

Returning to FIG. 5B, in the music data M stored in the music data 21b, as information related to a note, a note number of the note, the start time and the sounding duration described above, and an invalid flag are stored. The invalid flag refers to a flag that records whether an ornamental note has been set at the note. In the case where an ornamental note has not been set by the corresponding note, the invalid flag is set to be OFF. In the case where an ornamental note has been set by the corresponding note, the invalid flag is set to be ON.

Further, in the music data M of the music data 21b, instruction markers set with channel numbers, quantities of notes, and options are set as information related to instruction markers. Although not shown, the music data M of the music data 21b includes information related to a tempo of music and information related to a pedal including information on whether a hold pedal or a sostenuto pedal is pressed. In this embodiment, the tempo included in the “information related to a tempo” is defined as the number of seconds (i.e., actual time) per quarter note.

The music data M of the music data 21b may also store information other than information related to notes, instruction markers, a tempo, and a pedal. Further, the tempo included in the “information related to a tempo” is not limited to the number of seconds per quarter note, but may also be the number of seconds per other musical notes, such as the number of seconds per eighth note.

Next, referring to FIG. 6A, the parameter table 21c will be described. FIG. 6A is a view schematically showing the parameter table 21c. The parameter table 21c is a data table that stores detection conditions for detecting each ornamental note of an appoggiatura, an arpeggio, and a trill. The parameter table 21c stores the normal condition and the marker condition described above for each detection condition of an appoggiatura, an arpeggio, and a trill.

Specifically, as the normal conditions of an appoggiatura, the first time difference Lmin1 described above is set to “20 milliseconds”, and the second time difference Lmax1 is set to “40 milliseconds”. Further, the first predetermined number Nmin1 is set to “2 notes”, and the second predetermined number Nmax1 is set to “5 notes”. Furthermore, the velocity ratio Rg is set to “0.9”, and the maximum sounding duration Gd is set to “130 milliseconds”.

On the other hand, as the marker conditions of an appoggiatura, the first time difference Lmin1 is set to “10 milliseconds”, which is shorter than the normal condition; the second time difference Lmax1 is set to “80 milliseconds”, which is longer than the normal condition; the first predetermined number Nmin1 is set to “2 notes or marker specified number +1”; the second predetermined number Nmax1 is set to “5 notes or marker specified number +1”; the velocity ratio Rg is set to “0.5”, which is smaller than the normal condition; and the maximum sounding duration Gd is set to “500 milliseconds”, which is longer than the normal condition.

The “2 notes or marker specified number +1” in the first predetermined number Nmin1 indicates that, in the case where the “_Mn” option is appended to the appoggiatura marker, a number obtained by adding the quantity “1” of notes to which an appoggiatura is appended to the quantity “n” of notes to be taken as an appoggiatura specified by the “_Mn” option is used as the first predetermined number Nmin1, and in the case where the “_Mn” option is not appended, “2 notes” is used as the first predetermined number Nmin1.

Similarly, the “5 notes or marker specified number+1” of the second predetermined number Nmax1 indicates that, in the case where the “_Mn” option is appended to the appoggiatura marker, a number obtained by adding “1” to “n” specified by “n” in the “_Mn” option is used as the second predetermined number Nmax1, and in the case where the “_Mn” option is not appended, “5 notes” is used as the second predetermined number Nmax1. In other words, in the marker conditions of an appoggiatura, a number obtained by adding 1 to the quantity specified by the “_Mn” option of the appoggiatura marker is used as both the first predetermined number Nmin1 and the second predetermined number Nmax1. Accordingly, an appoggiatura composed of the quantity specified by the appoggiatura marker can be detected more reliably.

As the normal conditions of an arpeggio, the third time difference Lmin2 is set to “30 milliseconds”, the fourth time difference Lmax2 is set to “150 milliseconds”, the first average value LAmin is set to “60 milliseconds”, the second average value LAmax is set to “120 milliseconds”, the third predetermined number Nmin2 is set to “3 notes”, and the fourth predetermined number Nmax2 is set to “5 notes”.

On the other hand, as the marker conditions of an arpeggio, the third time difference Lmin2 is set to “20 milliseconds”, which is shorter than the normal condition; the fourth time difference Lmax2 is set to “200 milliseconds”, which is longer than the normal condition; the first average value LAmin is set to “20 milliseconds”, which is shorter than the normal condition; the second average value LAmax is set to “200 milliseconds”, which is longer than the normal condition; and each of the third predetermined number Nmin2 and the fourth predetermined number Nmax2 is set to “marker specified number”.

The “marker specified number” in the third predetermined number Nmin2 and the fourth predetermined number Nmax2 indicates that the quantity specified by “n” in the arpeggio marker is used as the third predetermined number Nmin2, and the quantity specified by “n” in the arpeggio marker is also used as the fourth predetermined number Nmax2. In other words, in the marker conditions of an arpeggio, the quantity specified by “n” in the arpeggio marker is used as both the third predetermined number Nmin2 and the fourth predetermined number Nmax2. Accordingly, an arpeggio composed of notes in the quantity specified by the arpeggio marker can be detected more reliably.

In this embodiment, the “predetermined ratio” among the detection conditions of an arpeggio is set to “80%” in both the normal condition and the marker condition. However, it is also possible to set different ratios for the normal condition and the marker condition, such as “80%” for the normal condition and “60%” for the marker condition.

As the normal conditions of a trill, the fifth time difference Lmin3 is set to “30 milliseconds”, the sixth time difference Lmax3 is set to “100 milliseconds”, and the fifth predetermined number Nt is set to “5 notes”. On the other hand, as the marker conditions of a trill, the fifth time difference Lmin3 is set to “10 milliseconds”, which is shorter than the normal condition; the sixth time difference Lmax3 is set to “150 milliseconds”, which is longer than the normal condition; and the fifth predetermined number Nt is set to “3 notes”, which is fewer than the normal condition.

In this manner, the marker conditions of the detection conditions for detecting each ornamental note are set to be conditions more relaxed than the normal conditions. For example, in the normal conditions of an appoggiatura, the first time difference Lmin1 is set to “20 milliseconds” and the second time difference Lmax1 is set to “40 milliseconds”; on the other hand, in the marker conditions of an appoggiatura, the first time difference Lmin1 is set to “10 milliseconds” and the second time difference Lmax1 is set to “80 milliseconds”.

Accordingly, the condition “equal to or greater than the first time difference Lmin1 and equal to or less than the second time difference Lmax1” among the marker conditions of an appoggiatura becomes a condition with a wider range than the corresponding condition in the normal conditions of an appoggiatura, and conditions with respect to the note-on time difference ΔL of the series of notes are relaxed. Thus, since a probability of acquiring a series of notes taken as ornamental notes of an appoggiatura to serve as ornamental notes of an appoggiatura can be increased, ornamental notes of an appoggiatura can be more reliably arranged on the sheet music to be outputted.

Returning to FIG. 5A. the RAM 22 is a memory for rewritably storing various work data and flags during execution of programs by the CPU 20, and is provided with sheet music data 22a and a tempo memory 22b that stores a tempo of the music data M of the music data 21b. Referring to FIG. 6B, the sheet music data 22a will be described.

FIG. 6B is a view schematically showing the sheet music data 22a. The sheet music data 22a stores music data to be outputted as sheet music. Specifically, in the sheet music data 22a, information related to normal notes, which are notes other than notes taken as ornamental notes, and information related to notes taken as ornamental notes in the music data M of the music data 21b are arranged in a sequence of being outputted as sheet music.

Similar to the music data 21b in FIG. 5B, as information related to a normal note, a note number of the note, and the start time and the sounding duration described above are set. A type (an appoggiatura, an arpeggio, or a trill) of the ornamental note, and a note number and a sounding duration of each of constituent notes which are notes constituting the ornamental notes are set as the information related to notes taken as ornamental notes. Hereinafter, the “information related to notes taken as ornamental notes” will be referred to as an “ornamental note pack”.

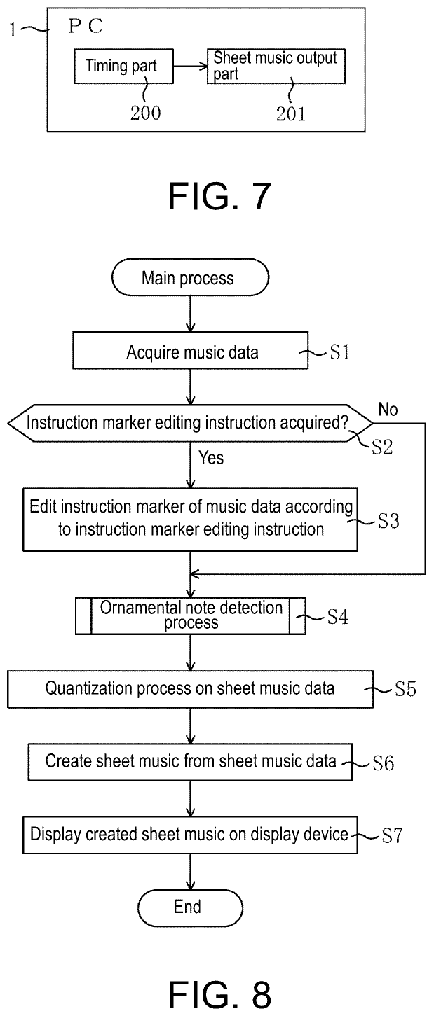

Next, referring to FIG. 7, functions of the PC 1 will be described. FIG. 7 is a functional block diagram of the PC 1. As shown in FIG. 7, the PC 1 includes a timing part 200 and a sheet music output part 201. The timing part 200 is a means for timing a note-on time difference ΔL between adjacent notes in a series of notes included in the music data M, and is implemented by the CPU 20. The sheet music output part 201 is a means for outputting sheet music on which ornamental notes corresponding to a series of notes are arranged in the case where the note-on time difference ΔL timed by the timing part 200 satisfies a predetermined detection condition, and the sheet music output part 201 is implemented by the CPU 20 and the display device 4.

In the PC 1, the note-on time difference ΔL of a series of notes included in the music data M is timed, and in the case where the note-on time difference ΔL satisfies the detection condition, musical notes in which ornamental notes corresponding to the series of notes are arranged are outputted. Accordingly, ornamental notes can be accurately acquired from a series of notes that should be taken as ornamental notes and in which the note-on time difference ΔL satisfies the detection condition, and ornamental notes can be accurately arranged on the outputted sheet music.

Next, referring to FIG. 8 to FIG. 13B, processes executed by the CPU 20 of the PC 1 will be described. FIG. 8 is a flowchart of a main process. The main process is a process executed in the case where an execution instruction for the sheet music output program 21a is sent in the PC 1. In the main process, first, music data M is acquired from the music data 21b (S1). In the following, the “music data M” refers to the music data M acquired in the process of S1.

After the process of S1, it is confirmed whether an instruction marker editing instruction, which is an instruction to edit an instruction marker in the music data M, has been acquired from the user H via the mouse 2 or the keyboard 3 (S2). In the case where acquisition of the instruction marker editing instruction is confirmed in the process of S2 (S2: Yes), the instruction marker in the music data M is edited according to the acquired instruction marker editing instruction (S3).

Specifically, a change of a position of the instruction marker in the music data M, a change of a setting of the instruction marker arranged in the music data M, or addition of a new instruction marker to the music data M is performed (S3). Accordingly, the content and the position of the instruction marker in the music data M can be in line with a setting of ornamental notes intended by the user H.

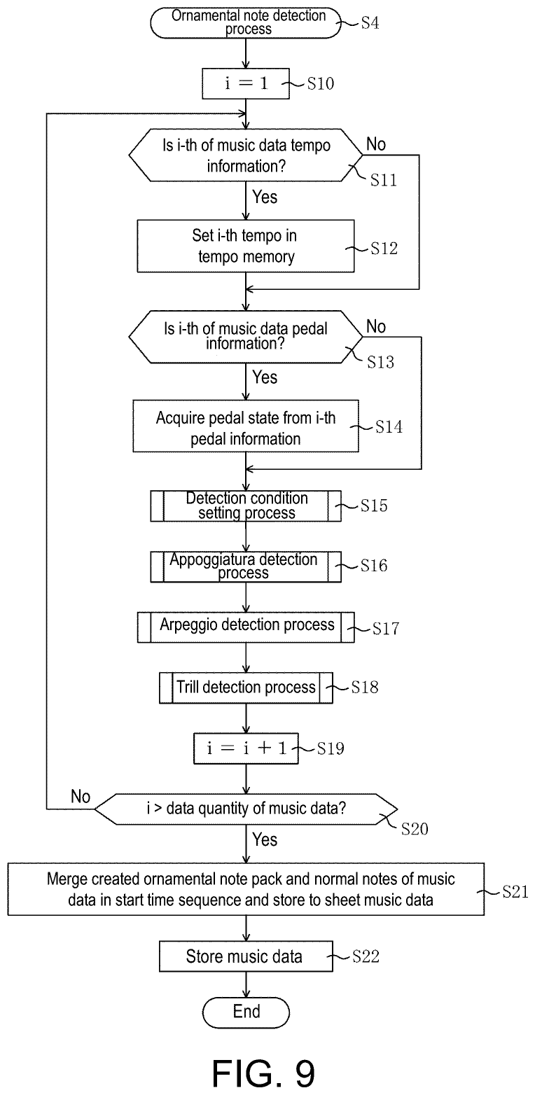

In the case where acquisition of the instruction marker editing instruction is not confirmed in the process of S2 (S2: No), the process of S3 is skipped. After the processes of S2 and S3, an ornamental note detection process (S4) is executed. Referring to FIG. 9, the ornamental note detection process will be described.

FIG. 9 is a flowchart of the ornamental note detection process. In the ornamental note detection process, first, a counter variable i, which represents a position (i.e., “No.” in FIG. 5B) of a note or an instruction marker in the music data M, is set to 1 (S10). After the process of S10, it is confirmed whether an i-th of the music data M is information related to a tempo in the performance information (S11).

In the case where it is confirmed that the i-th of the music data M is information related to a tempo in the process of S11 (S11: Yes), a tempo based on the acquired information related to a tempo is set in the tempo memory 22b (S12). On the other hand, in the case where it is not confirmed that the i-th of the music data M is information related to a tempo in the process of S11 (S11: No), the process of S12 is skipped.

After the processes of S11 and S12, it is confirmed whether the i-th of the music data M is information related to a pedal (S13). In the case where it is confirmed that the i-th of the music data M is information related to a pedal in the process of S13 (S13: Yes), a pedal state, which is a state indicating whether the pedal is pressed, is acquired from the acquired information related to a pedal (S14).

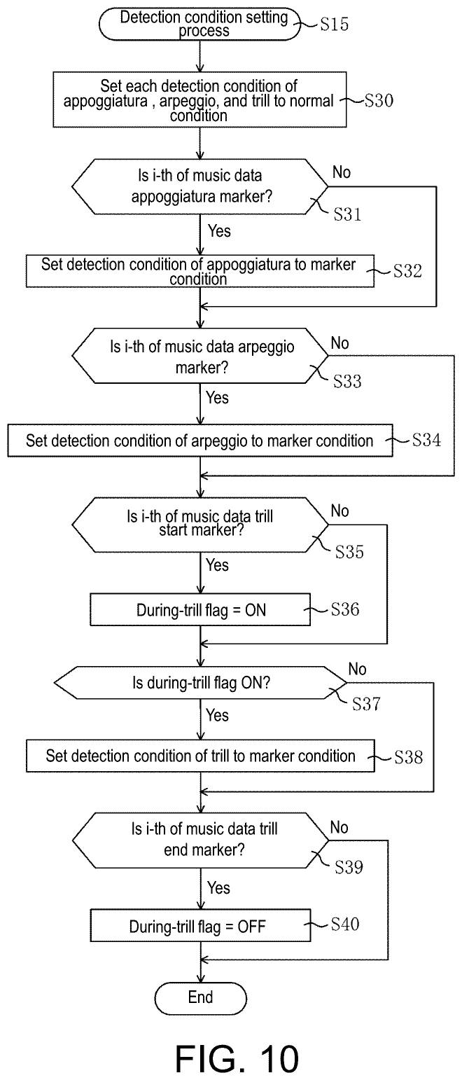

On the other hand, in the case where it is not confirmed that the i-th of the music data M is information related to a pedal in the process of S13 (S13: No), the process of S14 is skipped. After the processes of S13 and S14, a detection condition setting process (S15) is executed. Herein, referring to FIG. 10, the detection condition setting process will be described.

FIG. 10 is a flowchart of the detection condition setting process. In the detection condition setting process, first, a detection condition of each of an appoggiatura, an arpeggio, and a trill is set to a normal condition in the parameter table 21c (S30). After the process of S30, it is confirmed whether the i-th of the music data M is an appoggiatura marker (S31).

In the case where it is confirmed that the i-th of the music data M is an appoggiatura marker in the process of S31 (S31: Yes), the detection condition of an appoggiatura is set to a marker condition in the parameter table 21c (S32). On the other hand, in the case where it is not confirmed that the i-th of the music data M is an appoggiatura marker in the process of S31 (S31: No), the process of S32 is skipped.

After the processes of S31 and S32, it is confirmed whether the i-th of the music data M is an arpeggio marker (S33). In the case where it is confirmed that the i-th of the music data M is an arpeggio marker in the process of S33 (S33: Yes), the detection condition of an arpeggio is set to a marker condition in the parameter table 21c (S34). On the other hand, in the case where it is not confirmed that the i-th of the music data M is an arpeggio marker in the process of S33 (S33: No), the process of S34 is skipped.

After the processes of S33 and S34, it is confirmed whether the i-th of the music data M is a trill start marker (S35). In the case where it is confirmed that the i-th of the music data M is a trill start marker in the process of S35 (S35: Yes), a during-trill flag is set to ON (S36). The during-trill flag is a flag that indicates whether the detection condition of a trill is set to the marker condition, and the during-trill flag is set to ON in the case where a trill start marker is acquired from the music data M, and is set to OFF in the case where a trill end marker is acquired from the music data M. In the case where it is not confirmed that the i-th of the music data M is a trill start marker in the process of S35 (S35: No), the process of S36 is skipped.

After the processes of S35 and S36, it is confirmed whether the during-trill flag is ON (S37). In the case where it is confirmed that the during-trill flag is ON in the process of S37 (S37: Yes), the detection condition of a trill is set to the marker condition in the parameter table 21c (S38). On the other hand, in the case where it is confirmed that the during-trill flag is OFF in the process of S37 (S37: No), the process of S38 is skipped.

After the processes of S37 and S38, it is confirmed whether the i-th of the music data M is a trill end marker (S39). In the case where it is confirmed that the i-th of the music data M is a trill end marker in the process of S39 (S39: Yes), the during-trill flag is set to OFF (S40). On the other hand, in the case where it is not confirmed that the i-th of the music data M is a trill end marker in the process of S39 (S39: No), the process of S40 is skipped. After the processes of S39 and S40, the detection condition setting process is ended.

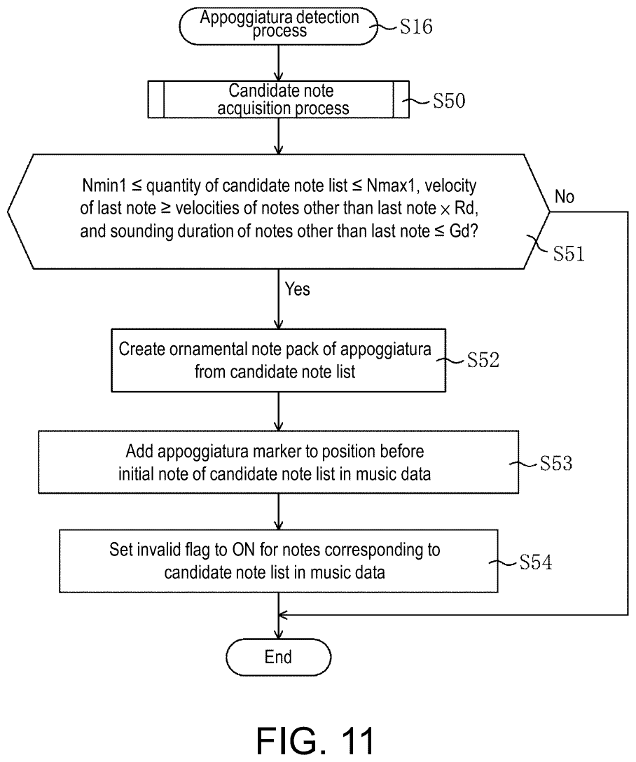

Returning to FIG. 9, after the detection condition setting process of S15, an appoggiatura detection process (S16), an arpeggio detection process (S17), and a trill detection process (S18) are executed. Referring to FIG. 11 to FIG. 13B, the appoggiatura detection process, the arpeggio detection process, and the trill detection process will be described.

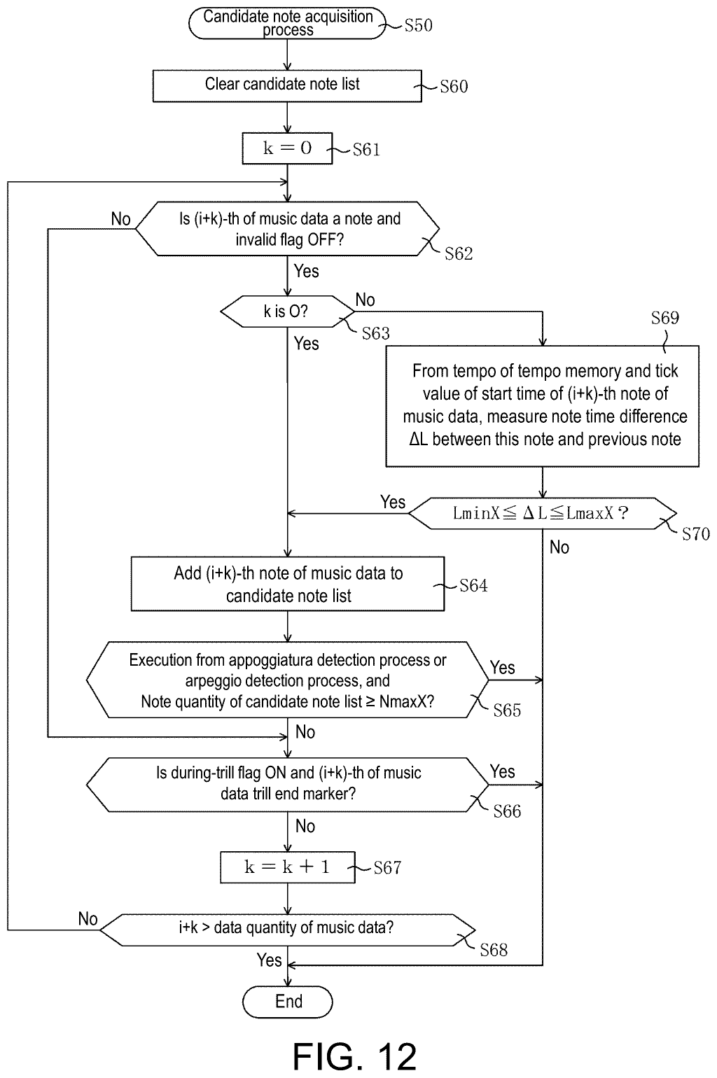

FIG. 11 is a flowchart of the appoggiatura detection process. In the appoggiatura detection process, first, a candidate note acquisition process is executed (S50). Herein, referring to FIG. 12, the candidate note acquisition process will be described.

FIG. 12 is a flowchart of the candidate note acquisition process. The candidate note acquisition process is a process that adds notes serving as detection targets of ornamental notes among the notes of the music data M to a candidate note list. From the notes set in the candidate note list, detection of ornamental notes is performed based on the appoggiatura detection process, the arpeggio detection process, and the trill detection process. Thus, the candidate note acquisition process is executed from the appoggiatura detection process and is also executed from the arpeggio detection process and the trill detection process to be described later.

In the candidate note acquisition process, first, the candidate note list is cleared (S60). After the process of S60, a counter variable k is set to 0 (S61). After the process of S61, it is confirmed whether an (i+k)-th of the music data M is a note and the invalid flag is OFF (S62). In the case where it is confirmed that the (i+k)-th of the music data M is a note and the invalid flag is OFF in the process of S62 (S62: Yes), it is confirmed whether the counter variable k is 0 (S63).

In the case where it is confirmed that the counter variable k is 0 in the process of S63 (S63: Yes), the (i+k)-th note of the music data M is added to the candidate note list (S64). At this time, information related to the (i+k)-th note of the music data M, specifically all of the note number, the start time, and the sounding duration, is added in association to the candidate note list.

After the process of S64, it is confirmed whether the candidate note acquisition process is executed from the appoggiatura detection process or the arpeggio detection process, and a quantity of notes in the candidate note list satisfies the detection condition of the corresponding ornamental note (S65). Specifically, whether the quantity of notes in the candidate note list satisfies the detection condition of the corresponding ornamental note is determined by confirming whether the quantity of notes in the candidate note list is equal to or greater than the second predetermined number Nmax1 in the case where the candidate note acquisition process is executed from the appoggiatura detection process. Further, in the case where the candidate note acquisition process is executed from the arpeggio detection process, it is confirmed whether the quantity of notes in the candidate note list is equal to or greater than the fourth predetermined number Nmax2.

The specific values such as the second predetermined number Nmax1 compared in the process of S65 are values acquired from the parameter table 21c based on the detection condition (normal condition or marker condition) set in the detection condition setting process of S15.

In the process of S65, in the case where it is not confirmed that the candidate note acquisition process is executed from the appoggiatura detection process or the arpeggio detection process, and the quantity of notes in the candidate note list satisfies the detection condition of the corresponding ornamental note (S65: No), it is confirmed whether the during-trill flag described above in FIG. 10 is ON and the i-th of the music data M is a trill end marker (S66).

In the case where it is not confirmed that the during-trill flag is ON and the i-th of the music data M is a trill end marker in the process of S66 (S66: No), 1 is added to the counter variable k (S67), and it is confirmed whether i+k is greater than the data quantity (i.e., a sum of a quantity of information related to notes and a quantity of information related to instruction markers in the music data M) in the music data M (S68). In the case where it is confirmed that i+k is equal to or less than the data quantity in the music data M in the process of S68 (S68: No), the processes from S62 onward are repeated.

In the case where it is confirmed that the counter variable k is greater than 0 in the process of S63 (S63: No), a note-on time difference ΔL between the (i+k)-th note of the music data M and a previous note added to the candidate note list is timed from the tempo in the tempo memory 22b and a tick value of the start time of the (i+k)-th note of the music data M (S69).

Specifically, first, a difference between the tick value of the start time of the (i+k)-th note of the music data M and the tick value of the start time of the previous note added to the candidate note list is calculated. Let the calculated difference value be Dt, the tempo in the tempo memory 22b be Tm, and the tick value per quarter note be Tq, and then the note-on time difference ΔL is calculated (timed) as “Dt×Tm/Tq”.

After the process of S69, it is confirmed whether the calculated note-on time difference ΔL satisfies the detection condition of the corresponding ornamental note (S70). Specifically, in the case where the candidate note acquisition process is executed from the appoggiatura detection process, it is confirmed whether the note-on time difference ΔL is equal to or greater than the first time difference Lmin1 and equal to or less than the second time difference Lmax1. In the case where the candidate note acquisition process is executed from the arpeggio detection process, it is confirmed whether the note-on time difference ΔL is equal to or greater than the third time difference Lmin2 and equal to or less than the fourth time difference Lmax2. In the case where the candidate note acquisition process is executed from the trill detection process, it is confirmed whether the note-on time difference ΔL is equal to or greater than the fifth time difference Lmin3 and equal to or less than the sixth time difference Lmax3.

The specific values such as the first time difference Lmin1 compared in the process of S70 are also values acquired from the parameter table 21c based on the detection condition (normal condition or marker condition) set in the detection condition setting process of S15.

In the case where it is confirmed that the note-on time difference ΔL satisfies the detection condition of the corresponding ornamental note in the process of S70 (S70: Yes), the process of S64 described above is executed. Further, in the case where it is not confirmed that the (i+k)-th of the music data M is a note and the invalid flag is OFF in the process of S62 (S62: No), the processes of S63 to S65, S69, and S70 are skipped.

In the case where it is confirmed that the candidate note acquisition process is executed from the appoggiatura detection process or the arpeggio detection process and the quantity of notes in the candidate note list satisfies the detection condition of the corresponding ornamental note in the process of S65 (S65: Yes), in the case where it is confirmed that the during-trill flag is ON and the i-th of the music data M is a trill end marker in the process of S66 (S66: Yes), in the case where it is confirmed that i+k is greater than the data quantity in the music data M in the process of S68 (S68: Yes), or in the case where it is not confirmed that the note-on time difference ΔL satisfies the detection condition of the corresponding ornamental note in the process of S70 (S70: No), it means that notes satisfying the detection condition of the corresponding ornamental note have been sufficiently registered in the candidate note list (S65, S66), that a note not satisfying the detection condition of the corresponding ornamental note has been detected (S70), or the processes of S63 to S70 have been completed up to the last data of the music data M. In such cases, the candidate note acquisition process is ended.

Returning to FIG. 11, after the candidate note acquisition process of S50, it is confirmed whether the quantity of notes in the candidate note list is equal to or greater than the first predetermined number Nmin1 and equal to or less than the second predetermined number Nmax1, the ratios of the velocity of the last note in the candidate note list to the velocities of the notes other than the last note in the candidate note list are all equal to or greater than the velocity ratio Rg, and the sounding durations of the notes other than the last note in the candidate note list are all equal to or less than the maximum sounding duration Gd (S51).

The specific values such as the first time difference Lmin1 compared in the process of S51 are values acquired from the parameter table 21c based on the detection condition set in the detection condition setting process of S15.

In the process of S51, in the case where it is confirmed that the quantity of notes in the candidate note list is equal to or greater than the first predetermined number Nmin1 and equal to or less than the second predetermined number Nmax1, the ratios of the velocity of the last note in the candidate note list to the velocities of the notes other than the last note in the candidate note list are equal to or greater than the velocity ratio Rg, and the sounding durations of the notes other than the last note in the candidate note list are all equal to or less than the maximum sounding duration Gd (S51: Yes), an ornamental note pack of an appoggiatura corresponding to the notes in the candidate note list is created (S52).

After the process of S52, an appoggiatura marker corresponding to the created appoggiatura is added to a position before the note that corresponds to the initial note in the candidate note list in the music data M (S53). In the process of S53, in the case where an appoggiatura marker is already arranged at the position before the note corresponding to the initial note in the candidate note list in the music data M, addition of the appoggiatura marker may be omitted, or the already arranged appoggiatura marker may be overwritten. The same applies to the processes of S92 and S93 to be described later in FIG. 13A and FIG. 13B.

After the process of S53, in the music data M, the invalid flag is set to ON for the notes corresponding to the notes in the candidate note list (S54). Accordingly, it is possible to suppress notes detected as an appoggiatura by the process of S52 from being erroneously detected as other ornamental notes.

In the process of S51, in the case where it is not confirmed that the quantity of notes in the candidate note list is equal to or greater than the first predetermined number Nmin1 and equal to or less than the second predetermined number Nmax1, the ratios of the velocity of the last note in the candidate note list to the velocities of the notes other than the last note in the candidate note list are all equal to or greater than the velocity ratio Rg, and the sounding durations of the notes other than the last note in the candidate note list are all equal to or less than the maximum sounding duration Gd (S51: No), or after the process of S54, the appoggiatura detection process is ended.

FIG. 13A is a flowchart of the arpeggio detection process. In the arpeggio detection process, first, the candidate note acquisition process of S50 described above is executed, and then an average value ΔLA of the respective note-on time differences ΔL calculated in the candidate note acquisition process is calculated (S80). After the process of S80, it is confirmed whether the calculated average value ΔLA is equal to or greater than the first average value LAmin and equal to or less than the second average value LAmax, the quantity of notes in the candidate note list is equal to or greater than the third predetermined number Nmin2 and equal to or less than the fourth predetermined number Nmax2, and the notes in the candidate note list are arranged in an ascending pitch sequence (S81). The specific values such as the first average value LAmin compared in the process of S81 are also values acquired from the parameter table 21c based on the detection condition set in the detection condition setting process of S15.

In the process of S81, in the case where it is confirmed that the average value ΔLA is equal to or greater than the first average value LAmin and equal to or less than the second average value LAmax, the quantity of notes in the candidate note list is equal to or greater than the third predetermined number Nmin2 and equal to or less than the fourth predetermined number Nmax2, and the notes in the candidate note list are arranged in an ascending pitch sequence (S81: Yes), it is confirmed whether the respective sounding periods of adjacent notes in the notes of the candidate note list overlap by a predetermined ratio or more, or whether the notes in the candidate note list are set in a period in which the pedal is pressed in the pedal state acquired in the process of S14 of the ornamental note detection process in FIG. 9 (S82).

In the process of S82, in the case where it is confirmed that the respective sounding periods of adjacent notes in the notes of the candidate note list overlap by the predetermined ratio or more, or the notes in the candidate note list are set in a period in which the pedal is pressed (S82: Yes), an ornamental note pack of an arpeggio corresponding to the notes in the candidate note list is created (S83). After the process of S83, an arpeggio marker corresponding to the created arpeggio is added to a position before the note corresponding to the initial note of the candidate note list in the music data M (S84). After the process of S84, in the music data M, the invalid flag is set to ON for the notes corresponding to the notes in the candidate note list (S85).

In the process of S81, in the case where it is not confirmed that the average value ΔLA is equal to or greater than the first average value LAmin and equal to or less than the second average value LAmax, the quantity of notes in the candidate note list is equal to or greater than the third predetermined number Nmin2 and equal to or less than the fourth predetermined number Nmax2, and the notes in the candidate note list are arranged in an ascending pitch sequence (S81: No), the processes S82 to S85 are skipped. In the process of S82, in the case where it is not confirmed that the respective sounding periods of adjacent notes in the notes of the candidate note list overlap by the predetermined ratio or more, or the notes in the candidate note list are set in a period in which the pedal is pressed (S82: No), the processes S83 to S85 are skipped. After the processes of S81, S82, and S85, the arpeggio detection process is ended.

FIG. 13B is a flowchart of the trill detection process. In the trill detection process, first, the candidate note acquisition process of S50 described above is executed, and then it is confirmed whether the quantity of notes in the candidate note list is equal to or greater than the fifth predetermined number Nt, and the notes in the candidate note list alternately repeat sounds that differ by a whole tone or a semitone (S90). The specific value of the fifth predetermined number Nt compared in the process of S90 is a value acquired from the parameter table 21c based on the detection condition set in the detection condition setting process of S15.

In the case where it is confirmed that the quantity of notes in the candidate note list is equal to or greater than the fifth predetermined number Nt, and the notes in the candidate note list alternately repeat sounds differing by a whole tone or a semitone in the process of S90 (S90: Yes), an ornamental note pack of a trill corresponding to the notes in the candidate note list is created (S91).

After the process of S91, a trill start marker corresponding to the created trill is added to a position before the note corresponding to the initial note of the candidate note list in the music data M (S92), and a trill end marker corresponding to the created trill is added to a position after the note corresponding to the last note of the candidate note list in the music data M (S93). After the process of S93, in the music data M, the invalid flag is set to ON for the notes corresponding to the notes in the candidate note list (S94).

In the case where it is not confirmed that the quantity of notes in the candidate note list is equal to or greater than the fifth predetermined number Nt, and the notes in the candidate note list alternately repeat sounds differing by a whole tone or a semitone in the process of S90 (S90: No), or after the process of S94, the trill detection process is ended.

Returning to FIG. 9, after the trill detection process of S18, 1 is added to the counter variable i, and it is confirmed whether the counter variable i is greater than the data quantity in the music data M (S20). In the case where it is confirmed that the counter variable i is equal to or less than the data quantity in the music data M in the process of S20 (S20: No), the processes from S11 onward are repeated.

In the case where it is confirmed that the counter variable i is greater than the data quantity in the music data M in the process of S20 (S20: Yes), music data obtained by merging, in a sequence of start time, each ornamental note pack created in the processes of S16 to S18 and the normal notes which are notes with the invalid flag being OFF in the music data M is stored to the sheet music data 22a (S21). At this time, a merge of the notes with the invalid flag being ON in the music data M into the music data of the sheet music data 22a is not performed.

After the process of S21, the music data M is stored to the music data 21b (S22), and the ornamental note detection process is ended. In the music data M, instruction markers are set with respect to the ornamental notes detected in the processes of S16 to S18. By storing (updating) such music data M to the music data 21b, in the processes of S16 to S18 based on the music data M of the music data 21b from a next time onward, the notes detected as ornamental notes in the processes of S16 to S18 this time will be subjected to detection of ornamental notes using marker conditions that are more relaxed than the normal conditions. Accordingly, since the probability that the notes detected as ornamental notes this time will also be detected as ornamental notes in the processes of S16 to S18 from a next time onward increases, ornamental notes can be set on the sheet music according to the intention of the user H.

Returning to FIG. 8, after the ornamental note detection process of S4, a quantization process is performed on the music data of the sheet music data 22a (S5). At this time, the start time of the ornamental note pack set in the music data of the sheet music data 22a is also arranged to the most approximate grid by the quantization process.

After the process of S5, sheet music is created from the quantized music data of the sheet music data 22a (S6), and the created sheet music is displayed on the display device 4 (S7). After the process of S7, the main process is ended.

Although the disclosure has been described based on the above embodiment, obviously, various improvements and modifications are possible.

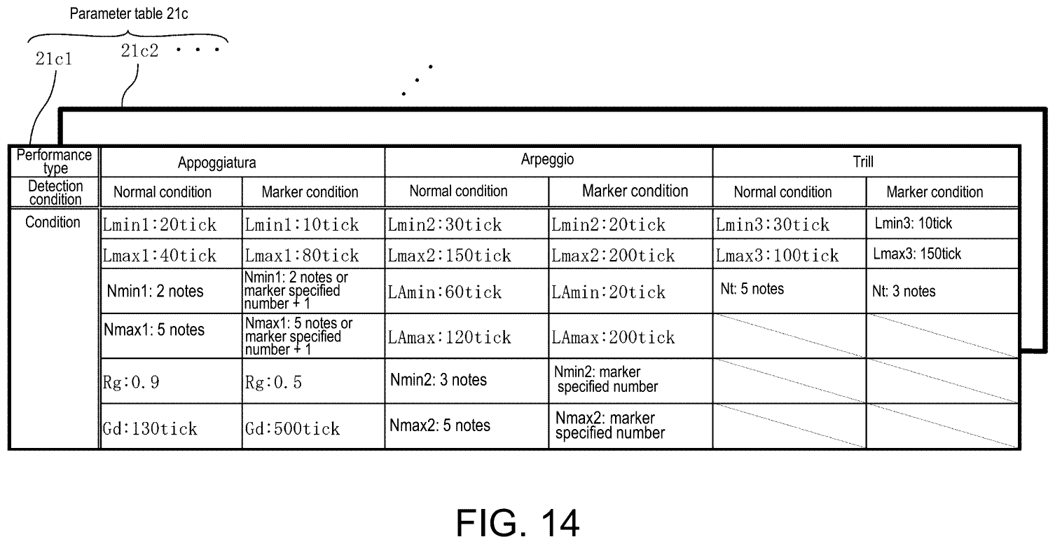

In the above embodiment, time-related conditions such as the first time difference Lmin1 in the parameter table 21c of FIG. 6A have been set in values based on seconds, such as “20 milliseconds”, and in the process of S69 in the candidate note acquisition process of FIG. 12, the note-on time difference ΔL has been calculated from the difference value Dt of the tick values of the start times of the target notes and the tempo in the tempo memory 22b, and compared with the first time difference Lmin1 and the like in the parameter table 21c. However, the disclosure is not limited thereto, and for example, as shown in the parameter table 21c of FIG. 14, time-related conditions such as the first time difference Lmin1 may also be set in tick values such as “20 ticks”, and compared with the difference value Dt of the tick values of the start times of the target notes in the process of S69.

At this time, in the parameter table 21c, tick values of respective time-related conditions corresponding to the tempo may be set in parameter tables 21c1, 21c2, . . . , and the parameter table 21c1, 21c2, . . . that matches or is most approximate to the tempo of the tempo memory 22b may be acquired and used for comparison in the process of S69. Accordingly, since it is not required to convert the difference value Dt, which is a tick value, to a time based on seconds in the process of S69, the comparison based on the process of S69 can be performed quickly.

In the above embodiment, the notes used for displaying sheet music have been acquired from the music data M stored in the music data 21b, but the source of notes is not limited thereto. For example, notes may also be acquired from music data M received by the PC 1 via wired or wireless communication, or notes received by the PC 1 via wired or wireless communication may also be acquired. Further, a MIDI keyboard may be connected to the PC 1, and notes inputted in real-time according to the user H's performance on the MIDI keyboard may be acquired.

In the above embodiment, in the detection condition of an appoggiatura, it has been determined whether the ratios of the velocity of the last note in a series of notes to the velocities of notes other than the last note in the series of notes are equal to or greater than the velocity ratio, but the disclosure is not limited thereto. For example, a velocity lower limit value, which is a predetermined lower limit value of velocity, may be set in advance, and it may be determined whether the velocity of the last note of a series of notes is equal to or greater than the velocity lower limit value. Alternatively, an offset value of velocity may be set in advance, and it may be determined whether the velocity of the last note of a series of notes is equal to or greater than a value obtained by adding the offset value to the velocities of all notes other than the last note among the series of notes.

In the above embodiment, each ornamental note has been acquired from the notes of the music data M according to the appoggiatura detection process, the arpeggio detection process, and the trill detection process in S16 to S18 of FIG. 9, but the disclosure is not limited thereto. For example, a learning model may be stored in the HDD 21, the learning model having been trained on the note-on time difference ΔL, the velocity, and the sounding duration of a series of notes, and the ornamental notes that should be detected therefrom. Then, in place of the processes of S16 to S18, the note-on time difference ΔL, the velocity, and the sounding duration of a series of notes acquired from the music data M may be inputted into the learning model stored in the HDD 21 to acquire ornamental notes corresponding to the series of notes. Accordingly, by using such a pre-trained learning model, acquisition of ornamental notes from a series of notes can be performed quickly and accurately.

In the above embodiment, sheet music has been outputted by displaying the created sheet music on the display device 4 in the process of S7 of the main process in FIG. 8, but the disclosure is not limited thereto. For example, the created sheet music may be outputted by transmitting the created sheet music from the PC 1 to an information processing device such as another computer via wireless or wired communication, or the sheet music may be outputted using other output means.

In the above embodiment, an appoggiatura, an arpeggio, and a trill have been illustrated as ornamental notes acquired from a series of notes in the music data M, but the disclosure is not limited thereto. For example, other ornamental notes such as a glissando or a portamento may also be acquired from a series of notes. In that case, detection conditions for detecting these ornamental notes may be appropriately set in the parameter table 21c.

In the above embodiment, instruction markers have been arranged between notes in the music data M, but the arrangement of instruction markers is not limited thereto. For example, in the music data M, notes alone may be arranged first, and after the arrangement of notes is completed, instruction markers may be arranged subsequently. Alternatively, in the music data M, instruction markers alone may be arranged first, and after the arrangement of instruction markers is completed, notes may be arranged subsequently. Alternatively, instruction markers may be stored in data different from the music data M. In such cases, information may be appended to an instruction marker to indicate which notes in the music data M are targeted by the instruction marker.

In the above embodiment, the PC 1 has been illustrated as a computer executing the sheet music output program 21a, but the disclosure is not limited thereto. The sheet music output program 21a may also be executed by an information processing device such as a smartphone or a tablet terminal, or an electronic musical instrument such as a synthesizer. Further, the disclosure may also be applied to a dedicated device (sheet music output device) that stores the sheet music output program 21a in a ROM or the like and executes only the sheet music output program 21a.

In the above embodiment, data in the MIDI format has been illustrated as the performance information of the music data, but the disclosure is not limited thereto. Data in other formats related to music than the MIDI may also be used as the performance information of the music data.

What is claimed is:

1. A non-transitory recording medium storing a sheet music output program that causes a computer to execute a sheet music output process outputting sheet music based on performance information,
the sheet music output program causing the computer to:
time a note-on time difference between adjacent notes in a series of notes included in the performance information, and
output sheet music on which ornamental notes corresponding to the series of notes are arranged in a case where the note-on time difference of the series of notes timed in the timing satisfies a predetermined detection condition.

2. The non-transitory recording medium according to claim 1, wherein
the timing comprises timing the note-on time difference based on actual time.

3. The non-transitory recording medium according to claim 2, wherein
the timing comprises timing actual time of the note-on time difference based on a tick value corresponding to the note-on time difference calculated from tick values corresponding to start times of respective notes of the series of notes, and a tempo based on the performance information.

4. The non-transitory recording medium according to claim 1, wherein
the computer comprises a storage device, and causes the storage device to act as a detection condition storage part that stores, for each tempo, the detection condition based on a tick value corresponding to the tempo,
the timing comprises timing a tick value corresponding to the note-on time difference from tick values corresponding to respective start times of the series of notes, and
the outputting of the sheet music comprises outputting sheet music on which ornamental notes corresponding to the series of notes are arranged in a case where the tick value corresponding to the note-on time difference of the series of notes timed in the timing satisfies the detection condition stored in the detection condition storage part corresponding to the tempo based on the performance information.

5. The non-transitory recording medium according to claim 1, wherein
the outputting of the sheet music comprises outputting sheet music on which ornamental notes of an appoggiatura are arranged as ornamental notes corresponding to the series of notes in a case where: the note-on time difference of the series of notes timed in the timing is equal to or greater than a first time difference and equal to or less than a second time difference, a quantity of notes of the series of notes is equal to or greater than a first predetermined number and equal to or less than a second predetermined number, a ratio of a velocity of a last note, which is a last note among the series of notes, to a velocity of a note other than the last note among the series of notes is equal to or greater than a velocity ratio, and a sounding duration of the note other than the last note among the series of notes is equal to or less than a maximum sounding duration.

6. The non-transitory recording medium according to claim 1, wherein
the outputting of the sheet music comprises outputting sheet music on which ornamental notes of an arpeggio are arranged as ornamental notes corresponding to the series of notes in a case where: the note-on time difference of the series of notes timed in the timing is equal to or greater than a third time difference and equal to or less than a fourth time difference, an average value of the note-on time difference of the series of notes is equal to or greater than a first average value and equal to or less than a second average value, a quantity of notes of the series of notes is equal to or greater than a third predetermined number and equal to or less than a fourth predetermined number, respective sounding periods of adjacent notes among the series of notes overlap by a predetermined ratio or more, and the series of notes is arranged in an ascending pitch sequence.

7. The non-transitory recording medium according to claim 1, wherein
the outputting of the sheet music comprises outputting sheet music on which ornamental notes of a trill are arranged as ornamental notes corresponding to the series of notes in a case where: the note-on time difference of the series of notes timed in the timing is equal to or greater than a fifth time difference and equal to or less than a sixth time difference, a quantity of notes of the series of notes is equal to or greater than a fifth predetermined number, and the series of notes alternately repeats sounds that differ by a whole tone or a semitone.

8. The non-transitory recording medium according to claim 1, wherein
the computer comprises a storage device, and causes the storage device to act as a model storage part that stores a learning model trained on the note-on time difference, a velocity, and a sounding duration of the series of notes, and ornamental notes that should be detected from the note-on time difference, the velocity, and the sounding duration of the series of notes, and
the outputting of the sheet music comprises outputting sheet music on which ornamental notes corresponding to the series of notes are arranged by inputting the note-on time difference of the series of notes timed in the timing, the velocity and the sounding duration of the series of notes into the learning model stored in the model storage part.

9. A sheet music output device outputting sheet music based on performance information, the sheet music output device comprising a processor configured to:
time a note-on time difference between adjacent notes in a series of notes included in the performance information, and
output sheet music on which ornamental notes corresponding to the series of notes are arranged in a case where the note-on time difference of the series of notes timed satisfies a predetermined detection condition.

10. A sheet music output method outputting sheet music based on performance information, the sheet music output method comprising:
timing a note-on time difference between adjacent notes in a series of notes included in the performance information; and
outputting sheet music on which ornamental notes corresponding to the series of notes are arranged in a case where the note-on time difference of the series of notes timed in the timing satisfies a predetermined detection condition.

11. The non-transitory recording medium according to claim 2, wherein
the outputting of the sheet music comprises outputting sheet music on which ornamental notes of an appoggiatura are arranged as ornamental notes corresponding to the series of notes in a case where: the note-on time difference of the series of notes timed in the timing is equal to or greater than a first time difference and equal to or less than a second time difference, a quantity of notes of the series of notes is equal to or greater than a first predetermined number and equal to or less than a second predetermined number, a ratio of a velocity of a last note, which is a last note among the series of notes, to a velocity of a note other than the last note among the series of notes is equal to or greater than a velocity ratio, and a sounding duration of the note other than the last note among the series of notes is equal to or less than a maximum sounding duration.

12. The non-transitory recording medium according to claim 3, wherein
the outputting of the sheet music comprises outputting sheet music on which ornamental notes of an appoggiatura are arranged as ornamental notes corresponding to the series of notes in a case where: the note-on time difference of the series of notes timed in the timing is equal to or greater than a first time difference and equal to or less than a second time difference, a quantity of notes of the series of notes is equal to or greater than a first predetermined number and equal to or less than a second predetermined number, a ratio of a velocity of a last note, which is a last note among the series of notes, to a velocity of a note other than the last note among the series of notes is equal to or greater than a velocity ratio, and a sounding duration of the note other than the last note among the series of notes is equal to or less than a maximum sounding duration.

13. The non-transitory recording medium according to claim 4, wherein
the outputting of the sheet music comprises outputting sheet music on which ornamental notes of an appoggiatura are arranged as ornamental notes corresponding to the series of notes in a case where: the note-on time difference of the series of notes timed in the timing is equal to or greater than a first time difference and equal to or less than a second time difference, a quantity of notes of the series of notes is equal to or greater than a first predetermined number and equal to or less than a second predetermined number, a ratio of a velocity of a last note, which is a last note among the series of notes, to a velocity of a note other than the last note among the series of notes is equal to or greater than a velocity ratio, and a sounding duration of the note other than the last note among the series of notes is equal to or less than a maximum sounding duration.

14. The non-transitory recording medium according to claim 2, wherein
the outputting of the sheet music comprises outputting sheet music on which ornamental notes of an arpeggio are arranged as ornamental notes corresponding to the series of notes in a case where: the note-on time difference of the series of notes timed in the timing is equal to or greater than a third time difference and equal to or less than a fourth time difference, an average value of the note-on time difference of the series of notes is equal to or greater than a first average value and equal to or less than a second average value, a quantity of notes of the series of notes is equal to or greater than a third predetermined number and equal to or less than a fourth predetermined number, respective sounding periods of adjacent notes among the series of notes overlap by a predetermined ratio or more, and the series of notes is arranged in an ascending pitch sequence.

15. The non-transitory recording medium according to claim 3, wherein
the outputting of the sheet music comprises outputting sheet music on which ornamental notes of an arpeggio are arranged as ornamental notes corresponding to the series of notes in a case where: the note-on time difference of the series of notes timed in the timing is equal to or greater than a third time difference and equal to or less than a fourth time difference, an average value of the note-on time difference of the series of notes is equal to or greater than a first average value and equal to or less than a second average value, a quantity of notes of the series of notes is equal to or greater than a third predetermined number and equal to or less than a fourth predetermined number, respective sounding periods of adjacent notes among the series of notes overlap by a predetermined ratio or more, and the series of notes is arranged in an ascending pitch sequence.

16. The non-transitory recording medium according to claim 4, wherein
the outputting of the sheet music comprises outputting sheet music on which ornamental notes of an arpeggio are arranged as ornamental notes corresponding to the series of notes in a case where: the note-on time difference of the series of notes timed in the timing is equal to or greater than a third time difference and equal to or less than a fourth time difference, an average value of the note-on time difference of the series of notes is equal to or greater than a first average value and equal to or less than a second average value, a quantity of notes of the series of notes is equal to or greater than a third predetermined number and equal to or less than a fourth predetermined number, respective sounding periods of adjacent notes among the series of notes overlap by a predetermined ratio or more, and the series of notes is arranged in an ascending pitch sequence.

17. The non-transitory recording medium according to claim 2, wherein
the outputting of the sheet music comprises outputting sheet music on which ornamental notes of a trill are arranged as ornamental notes corresponding to the series of notes in a case where: the note-on time difference of the series of notes timed in the timing is equal to or greater than a fifth time difference and equal to or less than a sixth time difference, a quantity of notes of the series of notes is equal to or greater than a fifth predetermined number, and the series of notes alternately repeats sounds that differ by a whole tone or a semitone.

18. The non-transitory recording medium according to claim 3, wherein
the outputting of the sheet music comprises outputting sheet music on which ornamental notes of a trill are arranged as ornamental notes corresponding to the series of notes in a case where: the note-on time difference of the series of notes timed in the timing is equal to or greater than a fifth time difference and equal to or less than a sixth time difference, a quantity of notes of the series of notes is equal to or greater than a fifth predetermined number, and the series of notes alternately repeats sounds that differ by a whole tone or a semitone.

19. The non-transitory recording medium according to claim 4, wherein
the outputting of the sheet music comprises outputting sheet music on which ornamental notes of a trill are arranged as ornamental notes corresponding to the series of notes in a case where: the note-on time difference of the series of notes timed in the timing is equal to or greater than a fifth time difference and equal to or less than a sixth time difference, a quantity of notes of the series of notes is equal to or greater than a fifth predetermined number, and the series of notes alternately repeats sounds that differ by a whole tone or a semitone.

20. The non-transitory recording medium according to claim 2, wherein
the computer comprises a storage device, and causes the storage device to act as a model storage part that stores a learning model trained on the note-on time difference, a velocity, and a sounding duration of the series of notes, and ornamental notes that should be detected from the note-on time difference, the velocity, and the sounding duration of the series of notes, and
the outputting of the sheet music comprises outputting sheet music on which ornamental notes corresponding to the series of notes are arranged by inputting the note-on time difference of the series of notes timed in the timing, the velocity and the sounding duration of the series of notes into the learning model stored in the model storage part.
